(19) United States
(12) Patent Application Publication
(10) Pub. No.: US 2024/0214941 A1
(43) Pub. Date: Jun. 27, 2024

(54) DYNAMIC MEASUREMENT REPORTING BASED ON USER EQUIPMENT CONDITIONS

(71) Applicant: T-MOBILE INNOVATIONS LLC, Overland Park, KS (US)

(72) Inventor: Raymond Reeves

(21) Appl. No.: 18/089,249

(22) Filed: Dec. 27, 2022

(51) Int. Cl. H04W 52/02; H04W 24/10; H04W 64/00

(52) U.S. Cl. CPC H04W 52/0277; H04W 24/10; H04W 52/0251; H04W 64/00

(57) ABSTRACT

Systems and method are provided for improving the energy efficiency of a wireless communication device that is configured to provide measurement reports characterizing the air interface. Conventionally, devices are configured to provide measurement reports at a static and predetermined interval. The present disclosure modifies the periodicity of measurement reports based on one or more of several factors including a device power state, proximity to other devices, and device movement. Under certain circumstances, the time between subsequent measurement reports is increased, conserving processing and transmission power of the affected device.

### SUMMARY

The present disclosure is directed, at least in part, to dynamically modifying the periodicity of measurement reports in wireless communication devices, substantially as shown in and/or described in connection with at least one of the figures, and as set forth more completely in the claims.

In aspects set forth herein, the energy efficiency of a user equipment (UE) is improved by way of a dynamic measurement reporting scheme. Modern wireless telecommunication networks utilize measurement reports from connected UEs in order to determine characteristics about the wireless environment that are used for various operation purposes (e.g., handover decisions and packet scheduling). Regular, that is to say static, measurement reporting intervals can be an energy-taxing burden for UEs—particularly UEs with limited power supplies. By modifying the conventional measurement reporting scheme to take into account device activity, power characteristics, and/or density of multiple devices, a wireless telecommunication network can selectively reduce the measurement reporting interval in a manner that conserves UE energy without compromising on valuable information used by the network to make operational decisions.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE SEVERAL VIEWS OF THE DRAWINGS

Implementations of the present disclosure are described in detail below with reference to the attached drawing figures, wherein:

FIG. 1 depicts an exemplary computing environment suitable for use in implementations of the present disclosure:

FIGS. 2A-2C depict exemplary network environments in which one or more implementations of the present disclosure may be employed; and

FIG. 3 depicts a flow diagram of an exemplary method for improving the power efficiency of user equipment by managing measurement reporting frequency, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. A base station suitable for use with the present disclosure may be terrestrial (e.g., a fixed/non-mobile form such as a cell tower or a utility-mounted small cell) or may be extra-terrestrial (e.g., an airborne or satellite form such as an airship or a satellite). The term “measurement report” is used to generally refer to one or more communications from a user equipment to a base station comprising one or more observations or indications characterizing the physical layer, channel state, signal propagation, available cells (e.g., serving cell, neighboring cell(s)), and the like, and may include information such as reference signal received power (RSRP) (e.g., synchronization signal or channel state information reference signal), reference signal received quality (RSRQ) (e.g., synchronization signal or channel state information reference signal), signal to noise interference ratios (SINR) (e.g., synchronization signal or channel state information reference signal), position and timing data (e.g., GPS timing of cell frames for UE positioning, GPS code measurements, GPS carrier phase measurements, reference signal timing difference, SFN and frame timing difference), or any other desirable metric such as but not limited to those discussed in ETSI TS 38.215(v17.1.0).

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, conventional wireless telecommunication networks utilize a measurement reporting paradigm in order to understand the performance of the physical and/or RRC layer, which in turn can be used for making radio resource management decisions, beam management decisions, and any other desirable operation. A user equipment (UE) is either pre-configured to perform measurement reporting according to a natively-programmed scheme or as instructed by a wireless network. Typically, in order to execute a measurement report, the UE performs one or more measurements, observations, and/or calculations relating to a reference signal transmitted from a radio access network of the wireless telecommunication network. Once the UE has prepared the measurement report, it then transmits said measurement report to the radio access network. Historically, network operators (and authors of technical specifications) have utilized/envisioned a measurement reporting scheme with either a static periodicity or an event-based trigger. For example, a network operator may instruct UEs to provide a measurement report once every second, with no regard as to the state of the UE. A UE may be instructed to execute a measurement report upon certain events (e.g., when a serving cell's RSRP exceeds/falls below a threshold, when a neighboring cell RSRP exceeds the RSRP of the serving cell, or other events that represent a change to the way that the UE ‘sees’ the radio access network)—again, agnostic to the state of the UE.

While conventional measurement reporting paradigms are arguably highly effective at providing significant amount of information regarding the state of the physical and RRC layers, they do so at the expense of UE processing resources. Executing (including transmitting) a measurement report requires the UE to expend local processing and transmission resources, both of which consume limited processing capabilities and electrical power. However, timely and accurate measurement reports support wireless connections between UEs and RANs by providing data to the RAN and broader wireless network that can be used to optimize transmission/propagation (e.g., beamforming, downlink power) operational decisions (e.g., handover and scheduling).

In contrast to conventional measurement reporting paradigms, the present disclosure is directed to systems, methods, and computer-readable media that create an improved measurement reporting scheme, from the standpoint of UE resource efficiency. Instead of flooding wireless networks with measurement reports at static intervals or potentially having lackluster measurement reporting if based solely on triggering events, aspects of the present disclosure dynamically adjust measurement reporting based on one or more conditions or characteristics of a UE. By, for example, reducing the measurement reporting frequency (for the avoidance of confusion, “measurement reporting frequency” refers to the rate that measurement reports are performed by the UE, not the RF frequency upon which they may be communicated) under certain circumstances, a UE can extend its battery life without significantly jeopardizing measurement reporting that supports an effective wireless connection to the radio access network.

Accordingly, a first aspect of the present disclosure is directed to a method for improving energy efficiency of a user equipment (UE). The method comprises receiving a power state information of the UE, wherein the power state information comprises a battery level of the UE. The method further comprises determining a current measurement reporting interval of the UE. The method further comprises determining a modified measurement reporting interval for the UE based at least in part on the power state information of the UE. The method further comprises communicating the modified measurement reporting interval to the UE.

Another aspect of the present disclosure is directed to a system for improving the efficiency of a user equipment (UE). The system comprises one or more base stations that provide wireless telecommunication services to subscribed UEs within a geographic area. The system further comprises one or more computer processing components configured to perform operations comprising determining that a set of UEs comprising a first UE and a second UE are located within the geographic area. The operations further comprise determining that the geographic area has an area less than a predetermined threshold. The operations further comprise communicating an instruction to the first UE to increase an amount of time that separates subsequent measurement reports based on said determinations.

Yet another aspect of the present disclosure is directed to a non-transitory computer readable media having instructions stored thereon, that when executed by one or more computer processing components, cause the one or more computer processing components to perform a method for improving the power efficiency of a user equipment (UE). The method comprises receiving one or more measurement report indicators associated with a UE, the one or more measurement report indicators comprising one or more of a power level, a density of UEs in an area comprising the UE, and a mobility of the UE. The method further comprises determining a modified measurement reporting interval based at least on a comparison of the received information to one or more predetermined thresholds. The method further comprises communicating an instruction to the UE to transmit measurement reports to a base station according to the modified measurement reporting interval.

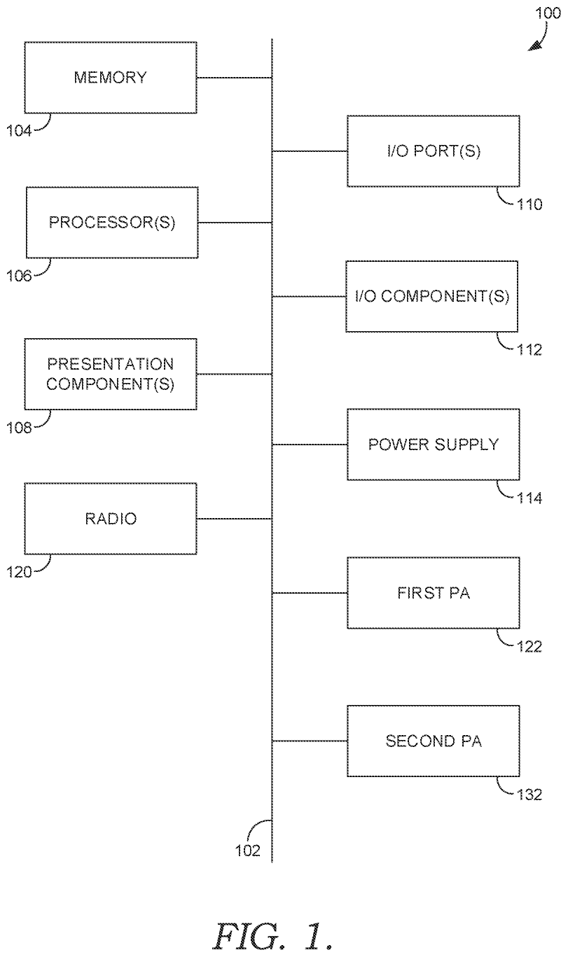

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment, wireless communication device, or user device, The computing device 100 may take many forms; non-limiting examples of the computing device 100 include a fixed wireless access device, cell phone, tablet, internet of things (IOT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

A first radio 120 and second radio 130 represent radios that facilitate communication with one or more wireless networks using one or more wireless links. In aspects, the first radio 120 utilizes a first transmitter 122 to communicate with a wireless network on a first wireless link and the second radio 130 utilizes the second transmitter 132 to communicate on a second wireless link. Though two radios are shown, it is expressly conceived that a computing device with a single radio (i.e., the first radio 120 or the second radio 130) could facilitate communication over one or more wireless links with one or more wireless networks via both the first transmitter 122 and the second transmitter 132. Illustrative wireless telecommunications technologies include CDMA, GPRS, TDMA, GSM, and the like. One or both of the first radio 120 and the second radio 130 may carry wireless communication functions or operations using any number of desirable wireless communication protocols, including 802.11 (Wi-Fi), WiMAX, LTE, 3G, 4G, LTE, 5G, NR, VOLTE, or other VoIP communications. In aspects, the first radio 120 and the second radio 130 may be configured to communicate using the same protocol but in other aspects they may be configure dot communicate using different protocols. In some embodiments, including those that both radios or both wireless links are configured for communicating using the same protocol, the first radio 120 and the second radio 130 may be configured to communicate on distinct frequencies or frequency bands (e.g., as part of a carrier aggregation scheme). As can be appreciated, in various embodiments, each of the first radio 120 and the second radio 130 can be configured to support multiple technologies and/or multiple frequencies; for example, the first radio 120 may be configured to communicate with a base station according to a cellular communication protocol (e.g., 4G, 5G, 6G, or the like), and the second radio 130 may configured to communicate with one or more other computing devices according to a local area communication protocol (e.g., IEEE 802.11 series, Bluetooth, NFC, z-wave, or the like).

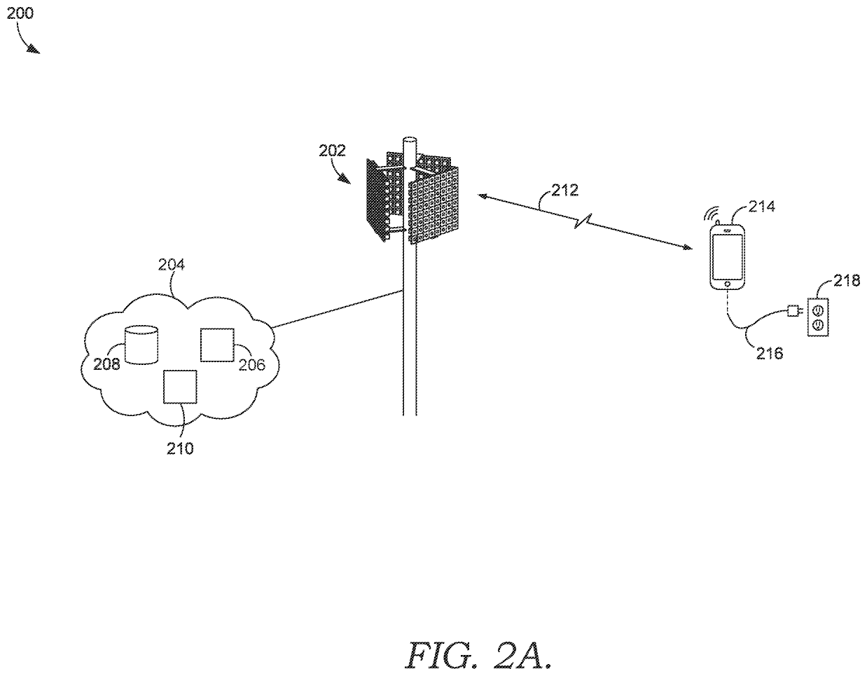

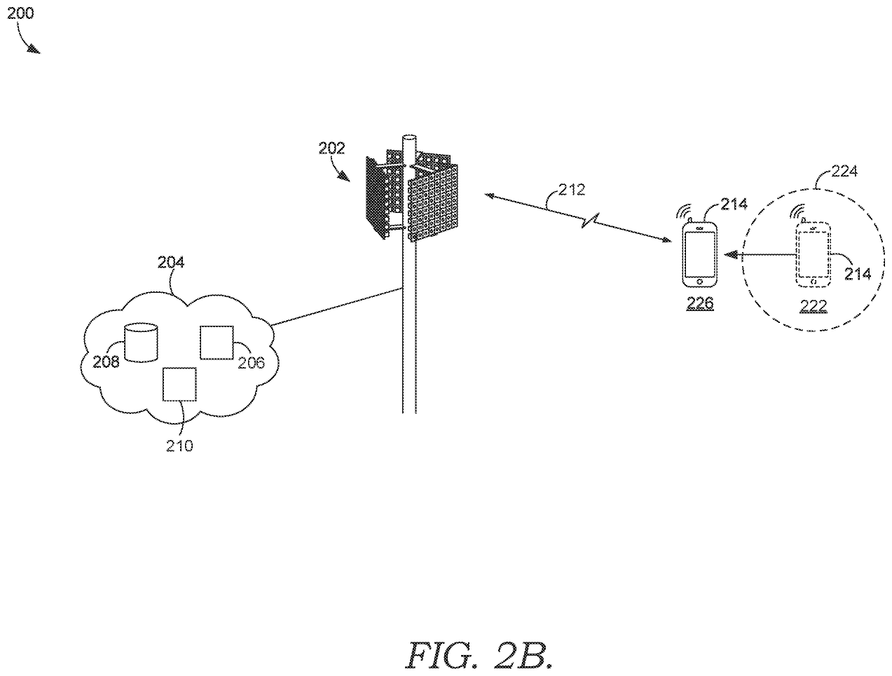

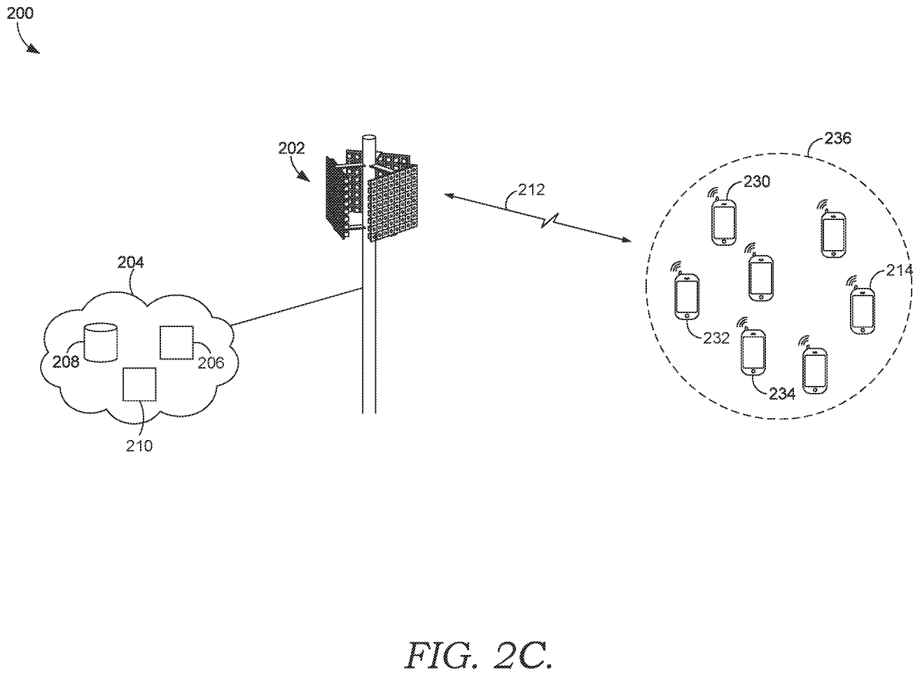

Turning now to FIGS. 2A-2C, a representative network environment in which the present disclosure may is illustrated. Such a network environment is illustrated and designated generally as network environment 200. Network environment 200 is but one example of a suitable network environment and is not intended to suggest, including by the form of any illustrated component thereof, any limitation as to the scope of use or functionality of the invention. Neither should the network environment be interpreted as having any dependency or requirement relating to any one or combination of components illustrated.

The network environment 200 generally represents a high-level model for wirelessly communicating between a base station and one or more user equipment (UE), as discussed in greater detail herein. At a high level, the network environment 200 comprises a base station 202, a network 204, at least one UE, and one or more computer processing or storage components configured to carry out the improved measurement reporting scheme disclosed herein.

The network environment comprises at least one base station 202 that is configured to wirelessly communicate with one or more UEs, such as the computing device 100 of FIG. 1, using a wireless communication link 212. For the purposes of this disclosure, a base station is used in its general sense, being defined as a station for transmitting and/or receiving RF signals: accordingly, the base station 202 may take the form of a cellular node (e.g. eNodeB, gNodeB, etc.), a relay, or any other desirable emitter and/or receiver of signals that wirelessly interfaces between the network 204 and one or more UEs. A suitable base station is not protocol-specific, it may be configured to be any wireless telecommunication protocol that is compatible with a UE, such as 4G, 5G, 6G, or any other wireless standard. A suitable base station is also not exclusive to cellular telecommunication networks, it may take the form of any wireless communication system and used at any desirable frequency (e.g., microwave relays). Base stations consistent with the present disclosure may be configured to serve a certain geographic area (i.e., a cell) and will have one or more backhaul connections that connect it to a broader telecommunications network, such as the network 204, for the provision of telecommunication service to one or more UEs. As illustrated, the base station 202 may take the form of a macro cell; however, the base station 202 may take any desirable form, such as a small cell. As seen in the illustrated embodiments, base stations suitable for use in the present disclosure may be terrestrial, that is, they are coupled to the earth via a tower or some other structure: alternatively, a suitable base station may be extra-terrestrial (i.e., coupled to an aircraft or a satellite).

In order to communicate with one or more UEs, the base station 202 may be said to communicate along a communication path 212 of the air interface, wherein one or more sets of downlink signals are sent to the one or more UEs from the base station 202 and one or more sets of uplink signals are communicated from the one or more UEs to the base station 202. Though illustrated as a straight line representing a single, direct, line of sight connection, one skilled in the art will appreciate that the reality of RF communications means that the communication path 212 may not be singular (i.e., there may be multiple paths), may not be direct (i.e., there may be reflections and/or refractions that cause the communication path 212 to have multiple or indirect paths), and it may not be line of sight (i.e., the communication path 212 may be reflected off structures, the ground, or the ionosphere, whether or not a direct line of sight connection exists). Though a single base station is illustrated in FIGS. 2A-2C, the network environment 200 may comprise multiple base stations, including multiple base stations that serve the same UE, such as through the use of dual connectivity technology; further, additional base stations may provide overlapping or auxiliary coverage in the event an outage occurs at the base station 202. Each base station of the network environment 200, including the base station 202, comprises one or more antennas that propagate to or receive signals from the air interface. Though illustrated as an antenna array, the one or more antennas of the base station 202 may take any desirable form, configured for the particular types of signaling between the base station 202 and the fixed wireless access device 204, including omni-directional, dipoles, single antenna systems, antenna arrays such as multiple-input, multiple-output (MIMO) and single-input, single-output (SISO) arrays, massive MIMO, and many others. For the purposes of present disclosure, it is sufficient to illustrate that one or more sets of downlink signals originate from, and/or that one or more uplink signals are received at, the base station 202 and the communication path 212 bridges the base station 202 and the one or more UEs wirelessly connected to the base station 202.

Common to FIGS. 2A-2C, the network environment comprises a network 204. The network 204 comprises any number of components that are generally configured to provide voice and/or data services to UEs that are wirelessly connected to the base station 202. For example, the network 204 may comprise one or more additional wireless base stations, a core network, an IMS network, a PSTN network, or any number of servers, computer processing components, and the like. The network 204 may include access to the World Wide Web, internet, or any number of desirable data sources which may be queried to fulfill requests from wireless communication devices that make requests via the base station 202. Additionally, the network may comprise one or more computer processing components (e.g., hardware and/or software stacks) such as a measurement reporting agent 206 and an operational support module 210; the network 204 may also comprise one or more data repositories such as data repository 208. Though illustrated as being within the network 204, one skilled in the art would appreciate that one or more components described herein may be disposed at or near the base station 202, between the base station 202 and the network 204, or split between multiple locations (e.g., multiple networks). As will be discussed in greater detail, the measurement reporting agent 206 is generally configured for making decisions regarding when measurement reports should be sent from a UE wirelessly connected to the base station 202, the data repository 208 is generally configured to store information about said UE, the base station 202, or other characteristics of the network environment 200 such as the locations and mobility of the UE and any other UEs served by the base station 202. The operational support module 210 is generally configured to provide the measurement reporting agent 206 with information about the capabilities of the base station 202 and provide a means for instructing the base station 202 when to request/instruct UEs to execute measurement reports.

The network environment 200 comprises a UE 214. The UE 214 may have any one or more features or characteristics of the computing device 100 described with respect to FIG. 1. In embodiments of the present disclosure, the UE 214 reports its power state to the base station 202: for example, the UE 214's power state may report a battery level, an external power state, and/or an indication of expected battery life remaining (e.g., an estimated remaining time on battery, a battery consumption rate with battery level which can be used to estimate the remaining time). The UE power state may be reported as part of a measurement report or it may be reported separate from the measurement report: if included with the measurement report, the UE 214 may report its power state with every measurement report, upon request from the base station 202, or at a predetermined interval (e.g., a time period or with every Nth number of measurement report). Regardless of when or how the UE 214 reports its power state, when the power state report is received by the base station 202, it is communicated to the measurement reporting agent 206. Upon receiving the power state of the UE 214, the measurement reporting agent 206 may utilize said information as at least one factor to determine whether (and if so, how) the measurement reporting frequency should be modified. The power state of the UE 214 may also be stored in the data repository 208 and then accessed by the measurement reporting agent 206 for use in future measurement reporting frequency decisions.

In a first aspect, the measurement reporting agent 206 may decrease the measurement reporting frequency (i.e., increase the time between each subsequent measurement report) based on the power state reported by the UE. The measurement reporting frequency may be modified based on the external power state of the UE; for example, if the UE is connected to an external power supply 216 (e.g., an AC adapter connected to a power receptacle 218, a DC battery bank, etc.), then the measurement reporting frequency may remain the same or increase, regardless of the battery level or other power state information of the UE 214. The external power state of the UE may, in some cases, be one of multiple factors used to modify the measurement reporting frequency: in aspects, if the UE 214 is not connected to an external power supply, then the measurement reporting frequency may be reduced based on the battery level of the UE 214 being at or below a predetermined threshold. For example, if the UE 214 is not connected to an external power supply and the UE 214 reports a battery level at or below a certain percentage (e.g., 10, 15, 20, 25%) or a remaining battery time less than a certain amount (e.g., 0.5, 1, 2, 4, 8 hours), then the measurement reporting agent 206 may decrease the measurement reporting frequency of the UE 214; whereas if the UE 214 provides an indication that the UE 214 is connected to an external power supply, then the measurement reporting frequency would remain unchanged or be increased. Further, the measurement reporting frequency of the UE 214 may be modified further based on the battery level being within any one of multiple power level bands. If the battery level of the UE 214 falls between a first and second threshold, the measurement reporting frequency may be modified from a default first frequency to a lesser second frequency, the measurement reporting frequency may be further reduced to an even lesser third frequency if the battery level continues to fall below the second threshold and is between the second and a third threshold, and the measurement reporting frequency may further reduce to a yet-lesser fourth frequency if the battery level falls below the third threshold. One skilled in the art would appreciate that any number of thresholds and corresponding modifications to the measurement reporting frequency could be implemented at the preference of a network operator.

In some implementations, such as those where the measurement reporting frequency has already been reduced or where the measurement report agent 206 has relatively fewer data points about the power state 214, the power state of the UE 214 may be estimated based on historical data. The measurement reporting agent 206 may determine a historical pattern of battery/power usage associated with a defined time period and determine that current conditions match the historical pattern: for example, the measurement reporting agent 206 may determine based on historical power state reports from the UE 214 that the UE 214 only utilizes 2% of battery per hour between 10 pm and 6 am, that the current time is 11 pm (within that window), and that the current battery level is sufficiently high that an amount of battery life will be remaining at the conclusion of the time window (e.g., if at least 5% of power at 6 am is the threshold, the current time is 11 pm, and the historic battery usage is 2% per hour, then measurement reporting frequency may be unchanged if the UE 214 reports a battery life of 19% or higher and reduced decreased if the battery life is less than 19%).

Turning now to FIG. 2B, a second aspect in which measurement reporting frequency is based on UE mobility is illustrated. In such an aspect, the measurement reporting frequency may increase or decrease based on motion of the UE 214. Modifications to the measurement reporting frequency may be reactive or proactive. In a reactive implementation, the UE 214, the network 204 and/or the base station 202 may determine that the UE 214 has moved beyond a predetermined threshold distance 224 of a first position 222 (e.g., by moving from the first position 222 to a second position 226). In some aspects gross movements of the UE 214 may be detected, for example based on one or sensors (e.g., positioning sensors such as a GPS module, or inertial such as an accelerometer). As used herein, the phrase gross movement is associated with the illustrated aspect of FIG. 2B, wherein the UE 214 moves beyond a boundary of a geographic area (e.g., a geofence) or a predetermined range of a starting point. As a result of a detection of a gross movement, the measurement report agent 206 may determine that the UE 214 is mobile and that measurement reporting frequency should be increased based on the potential that the gross movement could cause a material change in the channel conditions between the base station 202 and the UE 214; conversely, a cessation of gross movements of the UE 214 may be used as a basis for the measurement report agent 206 to decrease the measurement reporting frequency of the UE 214, based on an assumption that channel conditions between the base station 202 and the UE 214 are unlikely to suddenly change. In other aspects, even fine movements of the UE 214 may be used as a basis for modifying the measurement reporting frequency, wherein a detected movement by one or more sensors of the UE 214 can be used as an at least part of the basis for increasing the measurement reporting frequency: conversely, an absence of any movement of the UE 214 (e.g., overnight while on a nightstand) may be used as at least part of a basis for decreasing the measurement reporting frequency of the UE 214.

In a proactive implementation, historical activity of the UE 214 is used to determine that at a present day/time, the UE 214 is likely to move (or not move) at least the predetermined threshold distance 224 of its current position (e.g., based on historically moving at least the predetermined threshold distance 224 in previous instances of the day/time); for example, if the UE 214 historically moves more than the threshold distance between 5:30 pm and 6:00 pm during business days, then the measurement reporting frequency may be proactively modified during a present occurrence of it being 5:30 pm on a business day. In such an example, to better facilitate certain operational decisions (e.g., handovers between cells), the UE 214 may have its measurement reporting frequency increased (or remain constant) during times of relative high mobility and decreased during times of relative low mobility. Conversely, if it is determined that the UE 214 is immobile during a historic day/time (e.g., between 10:00 pm and 5:00 am on Monday-Friday, when a user may be asleep), then the measurement reporting frequency may be proactively reduced upon a present occurrence of being between said hours.

Turning now to FIG. 2C, a third aspect in which the measurement reporting frequency is based on UE density is illustrated. As illustrated, a condition may exist wherein the UE 214 is one UE of a set of UEs (e.g., including a second UE 230, a third UE 232, and a fourth UE 234) within a predetermined area/radius 236. In one practical example, the predetermined area 236 may represent a congregate landmark such as a concert venue, a sports arena, or a restaurant. A network operator may defined the predetermined area 236 based on a premise that information gleaned from each of the UEs located therein is (or will be) identical or within a predetermined threshold similar. For example, the predetermined area 236 may be defined as a static distance (e.g., 5, 10, 25, 100 yards) or may be defined as a dynamic area in which all of the set of UEs therein have measurement reports indicating that a particular value (e.g., RSRP) is within a predetermined threshold of similarity (e.g., 1, 5, or 10%). At least partially based on a determination that a greater than threshold number of devices are within the predetermined area 236 (i.e., that there is a sufficiently high UE density), the measurement reporting agent 206 may implement modifications to one or more UEs of the set of UEs. In a first aspect, UE density may be used in combination with power state information about a particular UE such as the first UE 214 to determine that the measurement reporting frequency of the first UE 214 should be modified. For example, the first UE 214 may be instructed to reduce its measurement reporting frequency based on a determination that is a member of the set of UEs with sufficient density and that the battery level of the first UE 214 is below a predetermined threshold. In another aspect, mobility may be used in combination with UE density and/or power state information. Continuing with the prior example, the first UE 214 may only have its measurement reporting frequency reduced based on being in an area of threshold high UE density, having threshold low mobility, and threshold low power. In other aspects, the measurement reporting agent 206 may make measurement reporting determinations for some or all of the UEs of the first set of UEs. For example, the measurement reporting agent may divide the set of UEs into a plurality of subsets (e.g., a first, second, and third subsets) and instruct only one subset to perform measurement reporting during a particular time (e.g., the first subset during a first measurement reporting time slot, the second subset during a second measurement reporting time slot, and the third subset during a third measurement reporting time slot). In some implementations, each of the power state of the UE 214, the mobility of the UE 214, and the density of a group of UEs including the UE 214 may be used alone or in various combinations by network operators to make measurement report frequency decisions, without departing from the present disclosure.

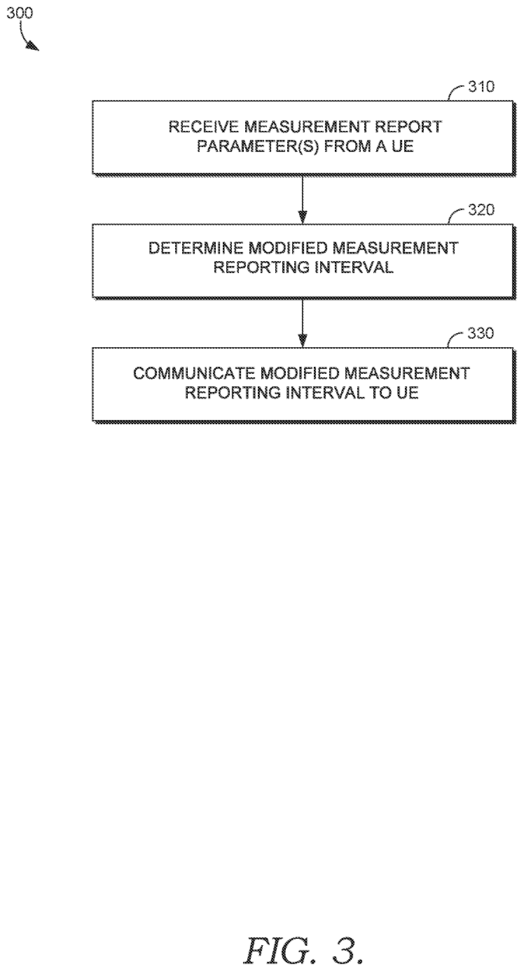

Turning to FIG. 3, a flow chart is provided that represents one or methods for dynamically modifying measurement reporting frequency of a UE. At a first step 310 one or more measurement report parameters are received by one or more computer processing components wherein the one or measurement report parameters comprise any one or more of a power level, UE density, and mobility of a particular UE, in accordance with any one or more aspects described with respect to FIGS. 2A-2C. At a second step 420 a modified measurement reporting interval (i.e., the time between subsequent measurement reports) is determined for the particular UE based at least on a comparison of the one or more received measurement report parameters with one or more predetermined thresholds, according to any one or more aspects described with respect to FIGS. 2A-2C. At a third step 330, an instruction is communicated from a base station to the UE to perform the measurement reporting procedure (including processing and transmitting the measurement report to the base station) at the modified reporting interval, according to any one or more aspects described with respect to FIGS. 2A-2C.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. A method for improving energy efficiency of a user equipment (UE), the method comprising:
receiving a power state information of the UE, wherein the power state information comprises a battery level of the UE;
determining a current measurement reporting interval of the UE;
based at least in part on the power state information of the UE,
determining a modified measurement reporting interval for the UE; and
communicating the modified measurement reporting interval to the UE.

2. The method of claim 1, wherein the power state information of the UE is reported in a measurement report.

3. The method of claim 2, wherein the power state information of the UE comprises an indication that the UE is disconnected from an external power supply.

4. The method of claim 3, wherein the power state information of the UE comprises an indication that the battery level of the UE is below a predetermined threshold and wherein the modified measurement reporting interval is less frequent than the current measurement reporting interval.

5. The method of claim 4, wherein determining the modified measurement reporting interval is further based on a determination that the UE is within a predetermined threshold distance of a threshold high number of additional UEs.

6. The method of claim 5, wherein determining the modified measurement reporting interval is further based on a determination that the UE has not moved beyond a predetermined threshold radius distance of a location within an immediately prior amount of time.

7. The method of claim 2, wherein the power state information of the UE comprises an indication that the UE is connected to an external power supply and wherein the modified measurement reporting interval is equal to or more frequent than the current measurement reporting interval.

8. The method of claim 1, wherein the modified measurement reporting interval of the UE is a first value based at least in part on the battery level of the UE being below a first predetermined threshold, and wherein the modified measurement reporting interval of the UE is a second value based at least in part on the battery level of the UE below a second predetermined threshold, the second predetermined threshold being less than the first predetermined threshold and the second value being less frequent than the first value.

9. The method of claim 1, wherein the power state information of the UE is received as a result of a query to a data repository comprising an indication of historical battery power levels for the UE.

10. A system for improving the efficiency of a user equipment (UE), the system comprising:
one or more base stations that provide wireless telecommunication services to subscribed UEs within a geographic area:
one or more computer processing components configured to perform operations comprising:
determining that a set of UEs comprising a first UE and a second UE are located within the geographic area:
determining that the geographic area has an area less than a predetermined threshold; and
based on said determinations, communicating an instruction to the first UE to increase an amount of time that separates subsequent measurement reports.

11. The system of claim 10, further comprising communicating an instruction to each UE of the set of UEs to increase the amount of time that separates subsequent measurement reports.

12. The system of claim 10, wherein communicating the instruction to the first UE is further based on a battery level of the first UE being reported as being below a predetermined threshold.

13. The system of claim 12, wherein the one or more computer processing components are further configured to communicate a second instruction to a second UE of the set of UEs to maintain the amount of time that separates subsequent reports based at least in part on a determination that a battery level of the second UE is greater than a second predetermined threshold.

14. The system of claim 12, wherein the one or more computer processing components are further configured to communicate a second instruction to a second UE of the set of UEs to decrease the amount of time that separates subsequent reports based at least in part on a determination that a battery level of the second UE is greater than a second predetermined threshold and that the battery level of the first UE is reported as being below the predetermined threshold.

15. The system of claim 12, wherein the one or more computer processing components are further configured to communicate a second instruction to a second UE of the set of UEs to increase the amount of time that separates subsequent measurement reports based at least in part on a determination that a battery level of the second UE is less than a second predetermined threshold.

16. The system of claim 12, wherein the one or more computer processing components are further configured to:
communicate a first instruction to a first subset of the set of UEs to transmit measurement reports during a first time period;
communicate a second instruction to a second subset of the set of UEs to transmit measurement reports during a second time period; and
communicate a third instruction to a third subset of the set of UEs to transmit measurement reports during a third time period, wherein the third time period is subsequent to the second time period, and wherein the second time period is subsequent to the first time period.

17. The system of claim 12, wherein communicating the instruction to the first UE is further based on an indication that the first UE is not connected to an external power supply.

18. The system of claim 12, wherein the battery level of the first UE is reported in a measurement report.

19. The system of claim 12, wherein the communicating the instruction to the first UE is further based on an indication that the first UE has not moved beyond a predetermined threshold radius distance of a location within an immediately prior amount of time.

20. One or more non-transitory computer readable media having instructions stored thereon that, when executed by one or more computer processing components, cause the one or more computer processing components to perform a method for improving the power efficiency of a user equipment (UE), the method comprising:
receiving one or more measurement report parameters associated with a UE, the one or more measurement report parameters comprising one or more of a power level, a density of UEs in an area comprising the UE, and a mobility of the UE;
determining a modified measurement reporting interval based at least on a comparison of the received parameters to one or more predetermined thresholds; and
communicating an instruction to the UE to transmit measurement reports to a base station according to the modified measurement reporting interval.
